(19) United States
(12) Patent Application Publication
(10) Pub. No.: US 2023/0249170 A1
(43) Pub. Date: Aug. 10, 2023

(54) HONEYCOMB STRUCTURE, ELECTRICALLY HEATING SUPPORT, AND EXHAUST GAS PURIFICATION DEVICE

(71) Applicant: NGK Insulators, Ltd., Nagoya-City (JP)

(72) Inventor: Ryosuke SAKAI, Nagoya-City (JP)

(73) Assignee: NGK Insulators, Ltd., Nagoya-City (JP)

(21) Appl. No.: 18/159,772

(22) Filed: Jan. 26, 2023

(30) Foreign Application Priority Data
Feb. 9, 2022 (JP) 2022-019086

(51) Int. Cl. B01J 35/00; B01J 35/04; B01D 53/94; F01N 3/20; F01N 3/28

(52) U.S. Cl. CPC B01J 35/0033; B01J 35/04; B01D 53/94; F01N 3/2026; F01N 3/2803; B01D 2255/9155; F01N 2330/30; F01N 2370/04

(57) ABSTRACT

A honeycomb structure includes: a honeycomb structure portion comprising: an outer peripheral wall; a partition wall; and at least one slit cut radially inward from the outer peripheral wall. The outer peripheral wall and the partition contain SiC and Si. The at least one slit is filled with a filling material. At least one of two regions sandwiched between the pair of electrode layers on the outer surface of the outer peripheral wall has an information recognition portion for displaying information, and the information recognition portion has an area of a color tone range of 0.36≤x≤0.38, 0.38≤y≤0.41, 14≤Y≤100 of 250 mm² or more in a CIExyY color space as defined in JIS Z 8781-3.

### CROSS REFERENCE TO RELATED APPLICATIONS

The present invention claims the benefit of priority to Japanese Patent Application No 2022-19086 filed on Feb. 9, 2022 with the Japanese Patent Office, the entire contents of which are incorporated herein by reference in its entirety.

### FIELD OF THE INVENTION

The present invention relates to a honeycomb structure, an electrically heating support, and an exhaust gas purification device.

### BACKGROUND OF THE INVENTION

Recently, electrically heated catalysts (EHCs) have been proposed to improve a decrease in exhaust gas purification performance immediately after engine starting. For example, the EHC is configured to connect metal electrodes to a pillar shaped honeycomb structure made of conductive ceramics, and conducting a current to heat the honeycomb structure itself, thereby enabling a temperature to be increased to an activation temperature of the catalyst prior to the engine starting.

Patent Literature 1 discloses an EHC using a honeycomb structure in which a partition wall and an outer peripheral wall are formed of SiC particles functioning as aggregate particles and a ceramic material containing Si for bonding the SiC particles.

### PRIOR ART

### Patent Literature

[Patent Literature 1] Japanese Patent Application Publication No. 2020-204300 A

### SUMMARY OF THE INVENTION

The EHC may display various information such as performance information, lot number, and management information, in its production steps or as a product. In general, the information is displayed on the outer peripheral wall of the honeycomb structure in various forms such as barcodes, letters, and marks by ink application (printing), imprinting with a stamp (stamping), laser irradiation with a laser marker (laser marking), or the like.

When the honeycomb structure of the EHC is formed of the ceramic material containing SiC and Si as described in Patent Literature 1, the appearance of the honeycomb structure is strongly blackish. If the honeycomb structure is strongly blackish, it is difficult to visually recognize the information because the information displayed on the outer peripheral surface of the honeycomb structure is often displayed in a black color. Furthermore, automatic recognition by image processing may also be difficult.

The present invention has been made in view of the above circumstances. An object of the present invention is to provide a honeycomb structure, an electrically heating support, and an exhaust gas purification device, which enable good recognition of displayed information.

The above problems are solved by the following present invention, and the present invention is specified as follows:

(1)

A honeycomb structure, comprising:

a honeycomb structure portion comprising: an outer peripheral wall; a partition wall disposed on an inner side of the outer peripheral wall, the partition wall defining a plurality of cells, each of the cells extending from one end face to other end face to form a flow path; and at least one slit cut radially inward from the outer peripheral wall, the at least one slit extending in an extending direction of the cells; and

a pair of electrode layers provided on an outer surface of the outer peripheral wall so as to extend in a form of a band in a flow path direction of the cells across a central axis of the honeycomb structure portion,

wherein the outer peripheral wall and the partition comprise SiC and Si,

wherein the at least one slit is filled with a filling material, and

wherein at least one of two regions sandwiched between the pair of electrode layers on the outer surface of the outer peripheral wall has an information recognition portion for displaying information, and the information recognition portion has an area of a color tone range of 0.36≤x≤0.38, 0.38≤y≤0.41, 14≤Y≤100 of 250 mm² or more in a CIExyY color space as defined in JIS Z 8781-3.

(2)

An electrically heating support comprising:

the honeycomb structure according to (1); and

a pair of metal electrodes electrically connected to the electrode layers of the honeycomb structure.

(3)

An exhaust gas purification device, comprising:

the electrically heating support according to (2); and

a metallic cylindrical member for holding the electrically heating support.

According to the present invention, it is possible to provide a honeycomb structure, an electrically heating support, and an exhaust gas purification device, which enable good recognition of displayed information.

### BRIEF DESCRIPTION OF THE DRAWINGS

FIG. 1 is a schematic external view of a honeycomb structure according to an embodiment of the present invention;

FIGS. 2A-2F are each schematic plane view of an outer peripheral wall on which an information recognition portion of a honeycomb structure according to an embodiment of the present invention is formed;

FIG. 3 is a schematic external view of a honeycomb structure according to another embodiment of the present invention; and

FIG. 4 is a schematic cross-sectional view of an electrically heating support according to an embodiment of the present invention, which is perpendicular to a flow path direction of cells.

### DETAILED DESCRIPTION OF THE INVENTION

Hereinafter, embodiments according to the present invention will be specifically described with reference to the drawings. It is to understand that the present invention is not limited to the following embodiments, and various design modifications and improvements may be made based on ordinary knowledge of one of ordinary skill in the art, without departing from the spirit of the present invention.

### (1. Honeycomb Structure)

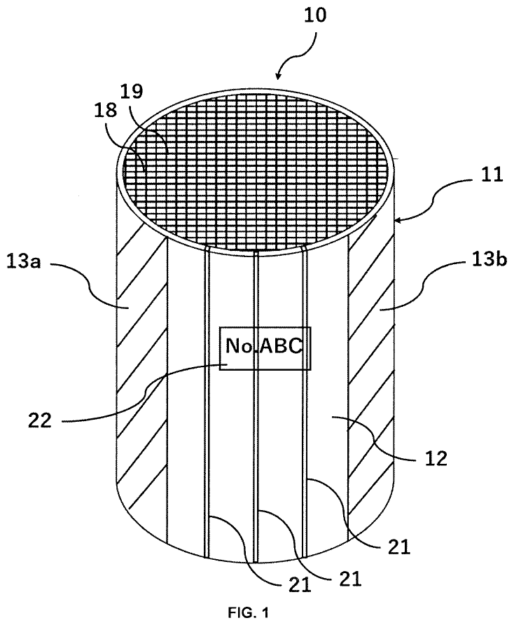

FIG. 1 is a schematic external view of a honeycomb structure 10 according to an embodiment of the present invention. The honeycomb structure 10 includes a honeycomb structure portion 11 and electrode layers 13a, 13b. Although FIG. 1 shows an example in which information (No. ABC) is displayed on the honeycomb structure 10, the honeycomb structure 10 may not display the information.

### (1-1. Honeycomb Structure Portion)

The honeycomb structure partition 11 is a pillar shaped member, and includes: an outer peripheral wall 12; and a partition wall 19 which is disposed on an inner side of the outer peripheral wall 12 and defines a plurality of cells 18 each extending from one end face to other end face to form a flow path. The pillar shape is understandable as a three-dimensional shape having a thickness in a flow path direction of the cells 18 (an axial direction of the honeycomb structure 11). A ratio (aspect ratio) of an axial length of the honeycomb structure 11 and a diameter or width of an end face of the honeycomb structure 11 is arbitrary. The pillar shape may also include a shape (flat shape) in which the length of the honeycomb structure portion 11 in the axial direction is shorter than the diameter or width of the end face.

An outer shape of the honeycomb structure portion 11 is not particularly limited as long as it is pillar shaped. For example, the honeycomb structure portion can have a shape such as a pillar shape with circular end faces (cylindrical shape), a pillar shaped with oval end faces, and a pillar shape with polygonal (quadrangular, pentagonal, hexagonal, heptagonal, octagonal, etc.) end faces. The size of the honeycomb structure portion 11 is such that an area of the end faces is preferably from 2000 to 20000 mm², and more preferably from 5000 to 15000 mm², for the purpose of improving heat resistance (suppressing cracks entering the outer peripheral wall in a circumferential direction).

The honeycomb structure portion 11 is made of ceramics and has electrical conductivity. A volume resistivity of the ceramics is not particularly limited as long as the conductive honeycomb structure portion 11 can be energized to generate heat by Joule heat, but it may preferably be 0.1 to 200 Ωcm, and more preferably 1 to 200 Ωcm. The volume resistivity of the honeycomb structure portion 11 is a value measured at 25° C. by a four-terminal method.

The outer peripheral wall 12 and the partition wall 19 making up the honeycomb structure portion 11 contain silicon carbide (SiC) and silicon (Si). Since the outer peripheral wall 12 and the partition wall 19 contain silicon carbide and silicon, both heat resistance and conductivity of the honeycomb structure 10 can be achieved. In order to achieve further improvement of heat resistance and conductivity, the outer peripheral wall 12 and the partition wall 19 preferably contain ceramics containing silicon-silicon carbide composite material as a main component. The phrase “the outer peripheral wall 12 and the partition wall 19 contain silicon-silicon carbide composite material as a main component” as used herein means that the outer peripheral wall 12 and the partition wall 19 contains 70% by mass or more of the silicon-silicon carbide composite material (total mass) relative to the whole. Here, the silicon-silicon carbide composite material contains silicon carbide particles as an aggregate and silicon as a bonding material for bonding the silicon carbide particles, and a plurality of silicon carbide particles are bonded by silicon so as to form pores between the silicon carbide particles.

When the outer peripheral wall 12 and the partition wall 19 contains the silicon-silicon carbide composite material, a ratio of a “mass of silicon as a bonding material” contained in the outer peripheral wall 12 and the partition wall 19 to the total of a “mass of silicon carbide particles as an aggregate” contained in the outer peripheral wall 12 and the partition wall 19 and a “mass of silicon as a bonding material” contained in the outer peripheral wall 12 and the partition wall 19 is preferably from 10 to 40% by mass, and more preferably from 15 to 35% by mass.

A shape of each cell in a cross section perpendicular to a flow path direction of the cells 18 is not limited, but it is preferably a quadrangle, a hexagon, an octagon, or a combination thereof. Among these, the quadrangle and the hexagon are preferred, in terms of easily achieving both structural strength and heating uniformity.

The partition wall 19 defining the cells 18 preferably has a thickness of from 0.1 to 0.3 mm, and more preferably from 0.1 to 0.2 mm. As used herein, the thickness of the partition wall 19 is defined as a length of a portion passing through the partition wall 19, among line segments connecting centers of gravity of the adjacent cells 18 in the cross section perpendicular to the flow path direction of the cells 18.

The honeycomb structure portion 11 preferably has a cell density of from 40 to 150 cells/cm², and more preferably from 70 to 100 cells/cm², in the cross section perpendicular to the flow path direction of the cells 18. The cell density in such a range can increase the purification performance of the catalyst while reducing the pressure loss upon flowing of an exhaust gas. The cell density is a value obtained by dividing the number of cells by an area of one end face of the honeycomb structure portion 11 excluding the outer peripheral wall 12 portion.

The provision of the outer peripheral wall 12 of the honeycomb structure portion 11 is useful in terms of ensuring the structural strength of the honeycomb structure portion 11 and preventing a fluid flowing through the cells 18 from leaking from the outer peripheral portion 12. More particularly, the thickness of the outer peripheral wall 12 is preferably 0.1 mm or more, and more preferably 0.15 mm or more, and even more preferably 0.2 mm or more. However, if the outer peripheral wall 12 is too thick, the strength becomes too high, so that a strength balance between the outer peripheral wall 12 and the partition wall 19 is lost to reduce thermal shock resistance. Therefore, the thickness of the outer peripheral wall 12 is preferably 1.0 mm or less, and more preferably 0.7 mm or less, and still more preferably 0.5 mm or less. As used herein, the thickness of the outer peripheral wall 12 is defined as a thickness of the outer peripheral wall 12 in a direction of a normal line to a tangential line at a measurement point when observing a portion of the outer peripheral wall 12 to be subjected to thickness measurement in the cross section perpendicular to the flow path direction of the cells.

The partition wall 19 may be porous. When the partition wall 19 is porous, the partition wall 19 preferably has a porosity of from 35 to 60%, and more preferably from 35 to 45%. The porosity is a value measured by a mercury porosimeter.

The partition wall 19 of the honeycomb structure portion 11 preferably has an average pore diameter of from 2 to 15 μm, and more preferably from 4 to 8 μm. The average pore diameter is a value measured by a mercury porosimeter.

### (1-2. Electrode Layer)

The honeycomb structure 10 includes a pair of electrode layers 13a, 13b on an outer surface of the outer peripheral wall 12 across a central axis of the honeycomb structure portion 11 so as to extend in a form of a band in the flow path direction of the cells 18. By thus providing the pair of electrode layer 13a, 13b, uniform heat generation of the honeycomb structure portion 11 can be enhanced. It is desirable that each of the electrode layers 13a, 13b extends over a length of 80% or more, and preferably 90% or more, and more preferably the full length, between both end faces of the honeycomb structure portion 11, from the viewpoint that a current easily spreads in an axial direction of each of the electrode layers 13a, 13b.

Each of the electrode layers 13a, 13b preferably has a thickness of from 0.01 to 5 mm, and more preferably from 0.01 to 3 mm. Such a range can allow uniform heat generation to be enhanced. The thickness of each of the electrode layers 13a, 13b is defined as a thickness in a direction of a normal line to a tangential line at a measurement point on an outer surface of each of the electrode layers 13a, 13b when observing the portion of each electrode portion to be subjected to thickness measurement in the cross section perpendicular to the flow path direction of the cells.

The volume resistivity of each of the electrode layers 13a, 13b is lower than the volume resistivity of the honeycomb structure portion 11, whereby the electricity tends to flow preferentially to the electrode layers 13a. 13b, and the electricity tends to spread in the flow path direction and the circumferential direction of the cells 18 during electric conduction. The volume resistivity of the electrode layers 13a, 13b is preferably 1/10 or less, and more preferably 1/20 or less, and even more preferably 1/30 or less, of the volume resistivity of the honeycomb structure portion 11. However, if the difference in volume resistivity between both becomes too large, the current is concentrated between ends of the opposing electrode layers to bias the heat generated in the honeycomb structure portion 11. Therefore, the volume resistivity of the electrode layers 13a, 13b is preferably 1/200 or more, and more preferably 1/150 or more, and even more preferably 1/100 or more, of the volume resistivity of the honeycomb structure portion 11. As used herein, the volume resistivity of the electrode layers 13a, 13b is a value measured at 25° C. by a four-terminal method.

Each of the electrode layers 13a, 13b may be made of conductive ceramics, a metal, and a composite of a metal and conductive ceramics (cermet). Examples of the metal include a single metal of Cr, Fe, Co, Ni, Si or Ti, or an alloy containing at least one metal selected from the group consisting of those metals. Non-limiting examples of the conductive ceramics include silicon carbide (SiC), metal compounds such as metal silicides such as tantalum silicide (TaSi₂) and chromium silicide (CrSi₂). Specific examples of the composite of the metal and the conductive ceramics (cermet) include a composite of metal silicon and silicon carbide, a composite of metal silicide such as tantalum silicide and chromium silicide, metal silicon and silicon carbide, and further a composite obtained by adding to one or more metals listed above one or more insulating ceramics such as alumina, mullite, zirconia, cordierite, silicon nitride, and aluminum nitride, in terms of decreased thermal expansion. The electrode layers 13a, 13b may preferably be made of a combination of the metal silicide such as tantalum silicide and chromium silicide with the composite of metal silicon and silicon carbide, among the above various metals and conductive ceramics, for the reason that they can be produced simultaneously with the honeycomb structure portion 11, which will contribute to simplification of the production step.

### (1-3. Slit)

The honeycomb structure portion 11 is provided with at least one slit 21 cut radially inward from the outer peripheral wall 12 and extending in the extending direction of the cells 18. Since the slit 21 provided in the honeycomb structure portion 11 functions to relax stress when the honeycomb structure 10 generates heat, it is possible to satisfactorily suppress cracking due to the generation of thermal expansion differences inside the honeycomb structure 10. Moreover, the slit 21 extending in the extending direction of the cells 18 is filled with a filling material, and the filling material functions as a gas sealing material that suppresses gas leakage from the slit 21.

The length and width of the slit 21 can be appropriately designed depending on the size, material, application of the honeycomb structure 10, and the number of the slits 21, and the like. The slit 21 may be provided throughout the extending direction of the cells 18 of the honeycomb structure portion 11, or may be provided so as to partially extend in the extending direction of the cells 18 of the honeycomb structure portion 11. The slit 21 may have a width of 1-2 cells, for example.

The depth of the slit 21 can also be appropriately designed depending on the size, material, application of the honeycomb structure 10, and the number of slits 21, and the like. For example, the slit 21 may have a depth of 1-5 cells from the outer peripheral wall 12 of the honeycomb structure portion 11 to the radially inward direction.

In the example as shown in FIG. 1, a total of three slits 21 are formed with certain intervals so as to extend from one end face to the other end face of the honeycomb structure 10 in the region sandwiched between the pair of electrode layers 13a, 13b on the outer surface of the outer peripheral wall 12. The number of slits 21 in the honeycomb structure 10 is not limited to this example, and it may be appropriately designed depending on the size, material, and application of the honeycomb structure 10, and the length, width and depth of the slits 21, and the like. For example, one slit 21 or two or more slits 21 may be provided in at least one of the two regions sandwiched between the pair of electrode layers 13a, 13b on the outer surface of the outer peripheral wall 12, or one or two or more slits 21 may be provided in both of the two regions, respectively.

The slits 21 contains the filling material. The interior of one slit 21 may be entirely filled with the filling material, or a part of the interior of the slit 21 may be filled with the filling material. From the viewpoint of the thermal shock resistance of the honeycomb structure 10, it is more preferable that the interior of the slit 21 is entirely filled with the filling material.

When a plurality of slits 21 are provided, all the slits 21 may contain the filling material, or only a part of the slits 21 may contain the filling material. From the viewpoint of the thermal shock resistance of the honeycomb structure 10, it is more preferable that all the slits 21 are filled with the filling material.

As the filling material, it is preferable to use a material that allows a coefficient of thermal expansion of the filling material to be close to that of the honeycomb structure portion 11. According to such a configuration, the thermal shock resistance of the honeycomb structure 10 can be improved. From this point of view, it is preferable that the filling material contains at least one of silicon carbide (SiC), silicon oxide (SiO₂), aluminum oxide (Al₂O₃), and magnesium oxide (MgO) as a main component. As used herein, the phrase “the filling material contains at least one of silicon carbide, silicon oxide, aluminum oxide, and magnesium oxide as a main component” means that the filling material contains 90% by mass or more of at least one (total mass) of silicon carbide, silicon oxide, aluminum oxide, and magnesium oxide based on the total filling material. As the filling material, plural kinds of filling materials may be used together. For example, the filling materials may be selectively used in one slit 21 depending on the positions, or they may be selectively used among the plurality of the slits 21.

The volume resistivity of the filling material is preferably 1 to 1000 times that of the honeycomb structure portion 11. When the volume resistivity of the filling material is 1 or more times that of the honeycomb structure 11, it is difficult for the current to flow through the filling material, so that the current is easy to uniformly flow through the honeycomb structure portion 11. There is no particular problem even if the volume resistivity of the filling material is higher. The filling material may be an insulator. The upper limit of the volume resistivity of the filling material is actually about 1000 times that of the honeycomb structure portion 11.

The filling material preferably has pores. A pore diameter of each pore contained in the filling material is not particularly limited, but it may be 1 to 500 μm.

The pore diameter (μm) of each pore contained in the filling material can be measured by cross-sectional observation with SEM. More particularly, first, a sample for observing the cross section of the filling material is cut out from the honeycomb structure having the slits containing the filling material, and the cross section is observed. If necessary, the irregularities of the cross section of the filling material are filled with a resin, and then polished, and the polished surface (cross section) is observed.

The filling material preferably has a porosity of 20 to 90%. The porosity of the filling material of 90% or less can sufficiently ensure the strength of the filling material, and prevent the filling material from collapsing and losing a gas leakage suppressing function. The porosity of the filling material of 20% or more can sufficiently maintain the stress relaxation function of the slits without excessively increase the Young's modulus of the filling material. More preferably, the porosity of the filling material is 30 to 85%, and even more preferably 45 to 75%.

The filling material preferably has a Young's modulus of 10 to 1000 MPa. The Young's modulus of the filling material of 10 MPa or more leads to good mechanical strength of the honeycomb structure 10. The Young's modulus of the filling material of 1000 MPa or less leads to better thermal shock resistance of the honeycomb structure 10. The Young's modulus of the filling material is more preferably 20 to 500 MPa, and even more preferably 50 to 200 MPa, and particularly preferably 100 to 200 MPa. The Young's modulus of the filling material can be calculated from the stress and strain at 20 to 50% stress loading in four-point bending strength measurement, as described in Japanese Patent No. 6259327 B.

The honeycomb structure portion 11 preferably has a Young's modulus of 1 to 100 GPa. The Young's modulus of 1 GPa or more of the honeycomb structure portion 11 leads to good mechanical strength of the honeycomb structure 10. The Young's modulus of 100 GPa or less of the honeycomb structure portion 11 leads to better thermal shock resistance of the honeycomb structure 10. The Young's modulus of the honeycomb structure portion 11 is more preferably 2 to 50 GPa, and even more preferably 5 to 20 GPa. The Young's modulus of the honeycomb structure portion 11 can be calculated from the stress and strain at a stress loading of 20 to 50% in four-point bending strength measurement.

### (1-4. Information Recognition Portion)

The honeycomb structure 10 has an information recognition portion 22 for displaying information in at least one of two regions sandwiched between the pair of electrode layers 13a, 13b on the outer surface of the outer peripheral wall 12. The information recognition portion 22 may be provided in only one of the two regions sandwiched between the pair of electrode layers 13a, 13b on the outer surface of the outer peripheral wall 12, or the information recognition portions 22 may be provided in both of the two regions.

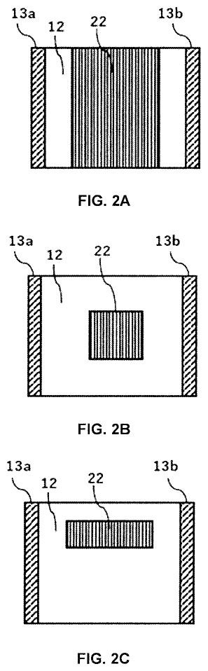

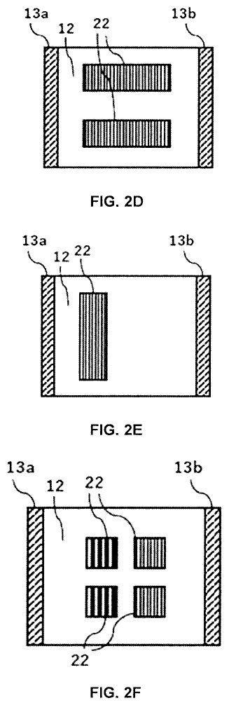

In the embodiment as shown in FIG. 1, the information recognition portion 22 forms a part of the outer peripheral wall 12. According to such a structure, the information recognition portion 22 can be produced at the same time when the outer peripheral wall 12 is produced, so that a production efficiency can be improved. In FIG. 1, a portion of the outer peripheral wall 12 that is not covered with the electrode layers 13a, 13b, i.e., a part of the exposed portion of the outer peripheral wall 12 forms the information recognition portion 22. The information recognition portion 22 may form the entire exposed portion of the outer peripheral wall 12. When a part of the exposed portion of the outer peripheral wall 12 forms the information recognition portion 22, specifically, it may have the embodiment as shown in each of FIG. 2A to FIG. 2F, for example.

Each of FIG. 2A to FIG. 2F is a schematic plane view of the region sandwiched between the pair of electrode layers 13a, 13b on the outer surface of the outer peripheral wall 12 of the honeycomb structure 10. In the embodiment as shown in FIG. 2A, the information recognition portion 22 is provided in a form of a band so as to extend from one end face to the other end face of the honeycomb structure 10 in a portion that is not covered with the electrode layers 13a, 13b on the outer surface of the outer peripheral wall 12. In the embodiment as shown in FIG. 2B, one information recognition portion 22 is provided in a form of an island at the center of the portion that is not covered with the electrode layers 13a, 13b on the outer surface of the outer peripheral wall 12.

In the embodiment as shown in FIG. 2C, the information recognition portion 22 is provided so as to extend in a form of a band in parallel to one end face on the one end face side of the honeycomb structure 10 at a portion that is not covered with the electrode layers 13a, 13b on the outer surface of the outer peripheral wall 12. In the embodiment as shown in FIG. 2D, the information recognition portions 22 are so as to extend in parallel to one end face and the other end face of the honeycomb structure 10 on the one end face side and the other end face side at a portion that is not covered with the electrode layers 13a, 3b on the outer surface of the outer peripheral wall 12.

In the embodiment as shown in FIG. 2E, the information recognition portion 22 is provided so as to extend in a form of a band in parallel to one electrode layer 13a of the honeycomb structure 10 on the one electrode layer 13a side in the portion that is not covered with the electrode layers 13a, 13b on the outer surface of the outer peripheral wall 12. In the embodiment as shown in FIG. 2F, the four information recognition portions 22 in total: two in each of lengthwise and crosswise in parallel are provided in the form of islands in the portion that is not covered with the electrode layers 13a, 13b on the outer surface of the outer peripheral wall 12.

The information recognition portion 22 may have a triangular, quadrangular, pentagonal or other polygonal shape, circular, elliptical, or other irregular shape as viewed in the plane.

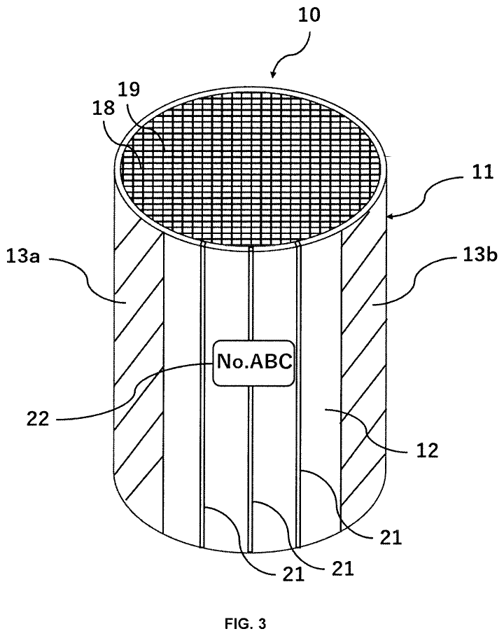

The information recognition portion 22 may be provided on the outer surface of the outer peripheral wall 12 as shown in FIG. 3. The information recognition portion 22 is formed in a layered shape having a predetermined thickness on the outer surface of the outer peripheral wall 12. According to such a structure, the layered information recognition portion 22 can be provided only at a portion where information is desired to be displayed on the outer surface of the outer peripheral wall 12, so that the production efficiency of the honeycomb structure 10 having the information recognition portion 22 can be improved. Further, since the layered information recognition portion 22 is further provided on the outer surface of the outer peripheral wall 12, the structural strength of the honeycomb structure portion 11 is improved.

The layered information recognition portion 22 preferably has a uniform thickness from the viewpoint of thermal shock resistance and canning property. The maximum thickness of the information recognition portion 22 provided on the outer surface of the outer peripheral wall 12 is preferably 0.01 times or more and 2.0 times or less that of the pair of electrode layers 13a, 13b. Such a structure reduces a difference between heat capacities of the information recognition portion 22 and the electrode layers 13a, 13b, so that thermal shock during heat generation can be mitigated and cracking can be satisfactorily suppressed. The EHC is inserted (canned) into a metallic cylindrical member while wrapping a mat around the outer peripheral surface of the honeycomb structure 10. In this case, a difference in surface pressure transmitted through the mat is eliminated, so that the holding force of the EHC after canning is improved. The maximum thickness of the information recognition portion 22 provided on the outer surface of the outer peripheral wall 12 is more preferably 0.1 times of more and 1.2 times or less, even more preferably 0.9 times or more and 1.1 times or less, that of the pair of electrode layers 13a, 13b. Each of the thickness of the information recognition portion 22 and the thickness of the electrode layers 13a, 13b is defined as a thickness of the information recognition portion 22 or the electrode layers 13a, 13b in a normal direction to a tangential line at a position for measuring the thickness when the measuring position of the information recognition portion 22 or the electrode layers 13a, 13b is observed in a cross section perpendicular to the flow path direction of the cells 18. Each of the maximum thickness of the information recognition portion 22 and the maximum thickness of the electrode layers 13a, 13b is defined as the maximum thickness among the thicknesses of the information recognition portion 22 and the electrode layers 13a and 13b measured at eight or more points.

The information recognition portion 22 has an area of a color tone range of 0.36≤x≤0.38, 0.38≤y≤0.41, 14≤Y≤100 of 250 mm² or more in a CIExyY color space as defined by JIS Z 8781-3 in at least one of the two regions sandwiched between the pair of electrode layers 13a, 13b on the outer surface of the outer peripheral wall 12. It should be noted that each of x and y represent chromaticity, respectively, and Y represents luminance. The area of the color tone range of 250 mm² or more can allow the information recognition portion 22 to be clearly distinguished from blackish color. Therefore, when information written in blackish color on the honeycomb structure 10 is displayed on the information recognition portion 22, the information can be well recognized. The color tone is preferably a color range of 0.36≤x≤0.38, 0.38≤y≤0.41, 36≤Y≤100 in order to achieve better recognition of information written in blackish color. Chromaticities x, y, and luminance Y in the CIExyY color space as defined by JIS Z 8781-3 (2016), which is the color tone of the information recognition portion 22, can be determined under conditions of room temperature (15 to 30° C.) and 85% RH or less using a color luminance meter CS-100A from Konica Minolta, Inc. An LED illumination or the like can be used as a light source for measurement. Further, the area of the color tone is preferably 400 mm² or more, and even more preferably over the entire information recognition portion 22. The area of the color tone can be calculated from an average value of three or more measurements.

A variation in color tone of the information recognition portion 22 is preferably in a range within ±2 of the median value of the luminance Y of the information recognition portion 22. Such a configuration can be close to a uniform color tone of the information recognition portion 22, thereby achieving better recognition of the displayed information. More preferably, the variation in color tone of the information recognition portion 22 is in a range within ±1 of the median value of the luminance Y of the information recognition portion 22. The median value of the color tone of the information recognition portion 22 can be measured by an average value measured at three or more points. Further, the variation in the color tone of the information recognition portion 22 is obtained by calculating the difference from the median value of the color tone of the information recognition portion 22 for the color tone.

The material making up the information recognition portion 22 is not particularly limited as long as it is a material that can obtain the above color tone of the information recognition portion 22. For example, a material containing SiC, Al₂O₃, or the like can be used. Preferably, the material making up the information recognition portion 22 contains silicon (Si). According to such a composition, when information is displayed by changing the color of the information recognition portion 22 by laser irradiation as described later, the color of the information recognition portion 22 is easily changed by laser irradiation, so that the information can be easily identified. The material making up the information recognition portion 22 preferably contains at least one of silicon carbide (SiC), silicon oxide (SiO₂), silica, aluminum oxide (Al₂O₃), cordierite, and magnesium oxide (MgO) as a main component. As used herein, the phrase “the material making up the information recognition portion 22 contains at least one of silicon carbide, silicon oxide, aluminum oxide, and magnesium oxide as a main component” means that the material making up the information recognition portion 22 contains 90% by mass or more of at least one (total mas) of silicon carbide, silicon oxide, aluminum oxide, and magnesium oxide, based on the entire information recognition portion 22. Such a composition can provide the color tone of the information recognition portion 22 as described above. Further, with these materials, the information recognition portion 22 will be formed of the same material as that of the filling material filled in the slits 21 of the honeycomb structure 10, so that the information recognition portion 22 and the filling material filled in the slits 21 will have the same or similar color tone. Therefore, the visibility of the information displayed on the information recognition portion 22 is not affected by the color of the filling material filled in the slits 21, so that the information can be better recognized. Further, the restriction of displaying information while avoiding the position of the slit 21 is eliminated, so that the degree of freedom of the displayed position of the information on the honeycomb structure 10 increases.

It is preferable that a ratio R₁/R₂ of a volume resistivity R₁ of the information recognition portion 22 to a volume resistivity R₂ of the electrode layers 13a, 13b is 100 or more. According to such a configuration, when the honeycomb structure 10 is used for EHC, an external current flowing from metal electrodes 33a, 33b, which will be described below, easily flows to the electrode layers 13a, 13b. Therefore, the external current can be efficiently used for heat generation of the EHC. The ratio R₁/R₂ of the volume resistivity R₁ of the information recognition portion 22 to the volume resistivity R₂ of the electrode layers 13a, 13b is more preferably 1000 or more. In the present invention, the volume resistivities R₁ and R₂ of the information recognition portion 22 and the electrode layers 13a, 13b are values measured at 25° C. by the four-terminal method.

### (1-5. Information)

The information recognition portion 22 of the honeycomb structure 10 may also have an embodiment where information is displayed. The information may be information displayed by laser irradiation or information displayed by ink, although not particularly limited thereto. The information displayed by laser irradiation is information displayed by irradiating the information recognition portion 22 with a laser and changing the color of the information recognition portion 22 by the heat of the laser. The information displayed by ink is information displayed by drawing or printing on the information recognition portion 22 with a heat-resistant ink or the like. Also, the information may be affixed with a stamp. From the viewpoint of obtaining the effects of the present invention more effectively, the information is preferably blackish. In FIGS. 1 and 3, the information is displayed as character information “No. ABC” in the information recognition portion 22, but the present invention is not limited thereto, and various forms of information such as barcodes, characters and marks may be displayed in the information recognition portion 22.

The information displayed by the information recognition portion 22 has an overall symbol grade (OSG) of D or more, i.e., A to D. The overall symbol grade is defined by the ISO/IEC 15415 standard. When the overall symbol grade of the information displayed by the information recognition portion 22 is D or more, the visibility of the information displayed by the information recognition portion 22 is more improved. The overall symbol grade of the information displayed by the information recognition portion 22 is more preferably C or more, and even more preferably B or more, and even more preferably A.

### (2. Electrically Heating Support)

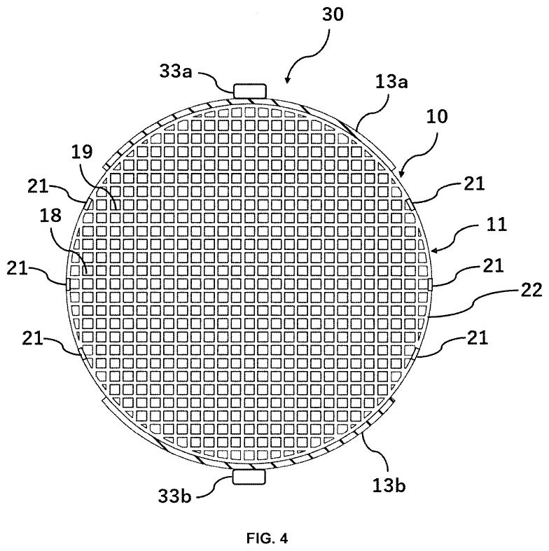

FIG. 4 is a schematic cross-sectional view of an electrically heating support 30 according to an embodiment of the present invention, which is perpendicular to the flow path direction of the cells. The electrically heating support 30 includes: the honeycomb structure 10; and metal electrodes 33a, 33b electrically connected to the electrode layers 13a, 13b of the honeycomb structure 10, respectively.

### (2-1. Metal Electrode)

The metal electrodes 33a, 33b are provided on the electrode layers 13a, 13b of the honeycomb structure 10. The metal electrode 33a, 33b may be a pair of metal electrodes such that one metal electrode 33a is disposed so as to face the other metal electrode 33b across the central axis of the honeycomb structure portion 11. As a voltage is applied to the metal electrodes 33a, 33b through the electrode layers 13a, 13b, then the electricity is conducted through the metal electrodes 33a, 33b to allow the honeycomb structure portion 11 to generate heat by Joule heat. Therefore, the electrically heating support 30 can also be suitably used as a heater. The applied voltage is preferably from 12 to 900 V, and more preferably from 64 to 600 V, although the applied voltage may be changed as needed.

The material of the metal electrodes 33a, 33b is not particularly limited as long as it is a metal, and a single metal, an alloy, or the like can be employed. In terms of corrosion resistance, electrical resistivity and linear expansion coefficient, for example, the material is preferably an alloy containing at least one selected from the group consisting of Cr, Fe, Co, Ni and Ti, and more preferably stainless steel and Fe—Ni alloys. The shape and size of each of the metal electrodes 33a, 33b are not particularly limited, and they can be appropriately designed according to the size of the electrically heating support 30, the electrical conduction performance, and the like.

By supporting the catalyst on the electrically heating support 30, the electrically heating support 30 can be used as a catalyst. For example, a fluid such as an exhaust gas from a motor vehicle can flow through the flow paths of the plurality of cells 18 of the honeycomb structure 10. Examples of the catalyst include noble metal catalysts or catalysts other than them. Illustrative examples of the noble metal catalysts include a three-way catalyst and an oxidation catalyst obtained by supporting a noble metal such as platinum (Pt), palladium (Pd) and rhodium (Rh) on surfaces of pores of alumina and containing a co-catalyst such as ceria and zirconia, or a NOx storage reduction catalyst (LNT catalyst) containing an alkaline earth metal and platinum as storage components for nitrogen oxides (NOx). Illustrative examples of a catalyst that does not use the noble metal include a NOx selective reduction catalyst (SCR catalyst) containing a copper-substituted or iron-substituted zeolite, and the like. Further, two or more catalysts selected from the group consisting of those catalysts may be used. A method for supporting the catalyst is not particularly limited, and it can be carried out according to a conventional method for supporting the catalyst on the honeycomb structure.

### (3. Method for Producing Honeycomb Structure)

Next, a method for producing the honeycomb structure according to an embodiment of the present invention will be described.

The method for producing the honeycomb structure according to an embodiment of the present invention includes: a forming step of preparing a honeycomb formed body; a drying step of preparing a honeycomb dried body; and a firing step of preparing a honeycomb fired body.

### (Forming Step)

In the forming step, first, a forming raw material containing a conductive ceramic raw material is prepared. The forming raw material is prepared by adding metal silicon powder (metal silicon), a binder, a surfactant(s), a pore former, water, and the like to silicon carbide powder (silicon carbide). It is preferable that a mass of metal silicon is from 10 to 40% by mass relative to the total of mass of silicon carbide powder and mass of metal silicon. The average particle diameter of the silicon carbide particles in the silicon carbide powder is preferably from 3 to 50 μm, and more preferably from 3 to 40 μm. The average particle diameter of the metal silicon (the metal silicon powder) is preferably from 2 to 35 μm. The average particle diameter of each of the silicon carbide particles and the metal silicon (metal silicon particles) refers to an arithmetic average diameter on a volume basis when frequency distribution of the particle size is measured by the laser diffraction method. The silicon carbide particles are fine particles of silicon carbide forming the silicon carbide powder, and the metal silicon particles are fine particles of metal silicon forming the metal silicon powder.

Examples of the binder include methyl cellulose, hydroxypropylmethyl cellulose, hydroxypropoxyl cellulose, hydroxyethyl cellulose, carboxymethyl cellulose, polyvinyl alcohol and the like. Among these, it is preferable to use methyl cellulose in combination with hydroxypropoxyl cellulose. The content of the binder is preferably from 2.0 to 10 parts by mass when the total mass of the silicon carbide powder and the metal silicon powder is 100 parts by mass.

The content of water is preferably from 20 to 60 parts by mass when the total mass of the silicon carbide powder and the metal silicon powder is 100 parts by mass.

The surfactant that can be used includes ethylene glycol, dextrin, fatty acid soaps, polyalcohol and the like. These may be used alone or in combination of two or more. The content of the surfactant is preferably from 0.1 to 2.0 parts by mass when the total mass of the silicon carbide powder and the metal silicon powder is 100 parts by mass.

The pore former is not particularly limited as long as the pore former itself forms pores after firing, including, for example, graphite, starch, foamed resins, water absorbing resins, silica gel and the like. The content of the pore former is preferably from 0.5 to 10.0 parts by mass when the total mass of the silicon carbide powder and the metal silicon powder is 100 parts by mass. An average particle diameter of D50 in a cumulative distribution on a volume basis of the pore former is preferably from 10 to 30 μm. When the pore former is the water absorbing resin, the average particle diameter of the pore former refers to an average particle diameter after water absorption.

The resulting forming raw material is then kneaded to form a green body, and the green body is then extruded to prepare a honeycomb structure. The honeycomb formed body includes: the outer peripheral wall; and the partition wall which is disposed on the inner side of the outer peripheral wall and defines the plurality of cells each extending from one end face to the other end face to form the flow path.

When a part of the outer surface of the outer peripheral wall in the region sandwiched between the pair of electrode layers is used as the information recognition portion having a desired color tone, the region of a part of the outer peripheral wall may be specified in the forming step, and the forming material may be changed in only that region to produce a honeycomb formed body.

When the information recognizing portion is provided on the outer surface of the honeycomb structure, an information recognition portion-forming paste is applied to a desired region of the outer peripheral wall of the honeycomb formed body having the outer peripheral wall and the partition wall so as to have a predetermined thickness, and this is dried in the drying step as described below. The information recognition portion-forming paste is produced by preparing a forming raw material that has a desired color tone after the drying and firing steps as described below.

### (Drying Step)

The resulting honeycomb formed body is then dried to produce a honeycomb dried body. The drying method is not particularly limited. Examples include electromagnetic wave heating methods such as microwave heating/drying and high-frequency dielectric heating/drying, and external heating methods such as hot air drying and superheated steam drying. Among them, it is preferable to dry a certain amount of moisture by the electromagnetic wave heating method and then dry the remaining moisture by the external heating method, in terms of being able to dry the entire molded body quickly and evenly without cracking. As for conditions of drying, it is preferable to remove 30 to 99% by mass of the water content before drying by the electromagnetic wave heating method, and then reduce the water content to 3% by mass or less by the external heating method. The dielectric heating/drying is preferable as the electromagnetic wave heating method, and hot air drying is preferable as the external heating method. The drying temperature may preferably be from 50 to 120° C.

At least one slit is then formed in the inner diameter direction from the outer peripheral wall of the honeycomb dried body. The slit can be formed using a cutting tool or the like according to a general slit forming method. It should be noted that the slit may not be formed on the honeycomb dried body, and after the honeycomb dried body is fired to produce the honeycomb fired body, the slit may be formed on the honeycomb fired body. The shape, number of slits, number of intersections, length, and width of the slit can be designed as needed depending on the desired characteristics of the honeycomb structure to be produced, and the like.

Before or after forming the slit, an electrode layer-forming raw material containing a ceramic raw material is applied to the side surface of the honeycomb dried body, and dried to form a pair of unfired electrode layers on the outer surface of the outer peripheral wall across the central axis of the honeycomb dried body so as to extend in a form of a band in the flow path direction of the cells, thereby producing a honeycomb dried body with unfired electrode layers. The electrode layer-forming raw material is applied to an appropriate position so as not to cover the information recognition portion.

The electrode layer-forming raw material can be formed by appropriately adding various additives to raw material powder (metal powder and/or ceramic powder, etc.) blended according to required properties of the electrode layers, and kneading the mixture.

The method of preparing the electrode layer-forming raw material and the method of applying the electrode layer-forming raw material to the honeycomb fired body can be carried out according to the known method for producing a honeycomb structure. In order to make the electric resistivity lower than that of the honeycomb structure portion, a metal content ratio can be increased or a particle diameter of the metal particles can be decreased as compared with that of the honeycomb structure portion.

### (Firing Step)

The honeycomb dried body with unfired electrode layers in which the slit has been formed is then fired to produce a honeycomb fired body. As the firing conditions, the honeycomb dried body is preferably heated in an inert atmosphere such as nitrogen and argon at 1400 to 1500° C. for 1 to 20 hours. Prior to the firing, degreasing may be carried out to remove the binder and the like. The degreasing step is carried out in an air atmosphere, an inert atmosphere, or a reduced pressure atmosphere at 400 to 500° C. After firing, an oxidation treatment is preferably carried out at 800 to 1350° C. for 1 to 10 hours in order to improve durability. The method of firing are not particularly limited, and it can be carried out using an electric furnace, a gas furnace, or the like. In addition, the electrode layers may be formed after the honeycomb fired body is produced. Specifically, once the honeycomb fired body is produced, a pair of unfired electrode layers may be formed on the honeycomb fired body, and fired to produce the honeycomb fired body with the pair of electrode layers.

### (Filling Step)

The filling of the slit with the filling material can be performed by filling the slit of the honeycomb fired body with the raw material for the filling material. The filling material may be filled in the slit at the stage of the honeycomb dried body. The filling material can be filled by a known method such as press-fitting with a spatula. The raw material for filling material is prepared by adding a binding material (such as metal silicon), a binder, a surfactant, a pore former, water, and the like to an aggregate. The aggregate preferably contains at least one of silicon carbide, silicon oxide, aluminum oxide, and magnesium oxide as a main component.

The pore former used for the raw material for the filling material is not particularly limited as long as it will form pores after firing, and examples include graphite, starch, foaming resins, water absorbing resins, silica gel, and the like. The content of the pore former is preferably 0.1 to 20 parts by mass, and more preferably 1 to 15 parts by mass, when the total mass of the aggregate and the binding material is 100 parts by mass. The pore former preferably has an average particle diameter of 3 to 150 μm.

When the pore former is the water absorbing resin, the average particle diameter of the pore former refers to an average particle diameter after water absorption.

From the viewpoint of workability when filling the slit with the raw material for filling material, the raw material for filling material preferably has a viscosity of 1 to 100 Pa·s.

The honeycomb fired body in which the filling material has been provided in the slit is then heated to produce a honeycomb fired body (honeycomb structure) including the slit provided with the filling material and the information recognition portion. The heating may preferably be carried out at 400 to 700° C. for 10 to 60 minutes. The heating (heat treatment) is carried out in order to strengthen a chemical bonding of the filling material. The heating method is not limited, and the firing may be carried out using an electric furnace, gas furnace, or the like.

### (4. Method for Producing Electrically Heating Support)

In one embodiment of the method for the electrically heating support 30 according to the present invention, the metal electrodes are fixed and electrically connected to the electrode layers on the honeycomb structure 10. Examples of the fixing method includes methods knowing the art such as laser welding, thermal spraying, and ultrasonic welding. More particularly, a pair of metal electrodes are provided on the outer surfaces of the electrode layers across the central axis of the honeycomb structure portion of the honeycomb structure 10. The electrically heating support 30 according to an embodiment of the present invention is thus obtained.

### (5. Exhaust Gas Purification Device)

The electrically heating support 30 according to the above embodiment of the present invention can be used for an exhaust gas purification device. The exhaust gas purification device includes the electrically heating support 30 and a metallic cylindrical member for holding the electrically heating support 30. In the exhaust gas purification device, the electrically heating support 30 can be installed in an exhaust gas flow path for allowing an exhaust gas from an engine to flow.

Hereinafter, embodiments are illustrated for better understanding of the present invention and its advantages, but the present invention is not limited to the embodiments.

### Embodiment 1

### (1. Production of Green Body)

Silicon carbide (SiC) powder and metal silicon (Si) powder are mixed in a mass ratio of 80:20 to prepare a ceramic raw material. To the ceramic raw material are added hydroxypropylmethyl cellulose as a binder, a water absorbing resin as a pore former, and water to form a forming raw material. The forming raw material is then kneaded by means of a vacuum green body kneader to prepare a cylindrical green body. The content of the binder is controlled to 7 parts by mass when the total of the silicon carbide (SiC) powder and the metal silicon (Si) powder is 100 parts by mass. The content of the pore former is controlled to 3 parts by mass when the total of the silicon carbide (SiC) powder and the metal silicon (Si) powder is 100 parts by mass. The content of water is controlled to 42 parts by mass when the total of the silicon carbide (SiC) powder and the metal silicon (Si) powder is 100 parts by mass.

### (2. Production of Honeycomb Formed Body)

The above cylindrical green body is formed using an extruding machine having a grid-shaped die structure to produce a cylindrical honeycomb formed body in which each cell has a hexagonal shape in a cross section perpendicular to the flow path direction of the cells.

To the honeycomb formed body, an information recognition portion-forming paste having a thickness of 0.08 mm is applied to form a rectangle of length×width=6.5 cm×4.6 cm as viewed in the plane so as to cover the slit portions of the outer peripheral wall as shown in FIG. 3. When preparing the information recognition portion-forming paste, first, a neck material made of silica, an aggregate made of silicon carbide, and an aggregate made of cordierite were mixed. Hereinafter, the aggregate made of silicon carbide may be referred to as “SiC aggregate”. The cordierite aggregate may be referred to as “Cd aggregate”. The neck material, the SiC aggregate, and the Cd aggregate are mixed so that the mass ratio is 12:6:82 (neck material:SiC aggregate:Cd aggregate). Hydroxypropyl methylcellulose as a binder, glycerin as a humectant, a surfactant as a dispersant, and a pore former are added to this, and water is also added and mixed. The resulting mixture is kneaded to form the information recognition portion-forming paste. The content of the binder is 1.0 part by mass when the total of the neck material, the SiC aggregate and the Cd aggregate is 100 parts by mass. The content of glycerin is 4.0 parts by mass when the total of the neck material, the SiC aggregate and the Cd aggregate is 100 parts by mass. The content of the surfactant is 0 parts by mass when the total of the neck material, the SiC aggregate and the Cd aggregate is 100 parts by mass. The content of water is 34.5 parts by mass when the total of the neck material, the SiC aggregate and the Cd aggregate is 100 parts by mass. The content of the pore former is 6.7 parts by mass when the total of the neck material, the SiC aggregate and the Cd aggregate is 100 parts by mass. The average particle diameter of the SiC aggregate used as the raw material for the filling material is, for example, 3 μm, and the average particle diameter of the Cd aggregate is 8 μm. The average particle diameters of the SiC aggregate and the Cd aggregate are measured by a laser diffraction method.

### (3. Production of Honeycomb Dried Body)

The honeycomb formed body with information recognition portion-forming paste is then dried by high frequency dielectric heating, and then dried at 120° C. for 2 hours using a hot air dryer to produce a honeycomb dried body.

### (4. Preparation of Slit)

Slits as shown in FIG. 3 are formed on a predetermined side surface of the honeycomb dried body. More particularly, six slits in total: three slits on each side surface across the central axis of the honeycomb structure body, are formed on a predetermined side surface of the honeycomb dried body so as to extend from one end face to the other end face by a cutting tool.

### (5. Preparation and Application of Electrode Portion-Forming Paste)

Metal silicon (Si) powder, silicon carbide (SiC) powder, methyl cellulose, glycerin, and water are mixed in planetary centrifugal mixer to prepare an electrode portion-forming paste. The Si powder and the SiC powder are blended so that the volume ratio is Si powder:SiC powder=40:60. Further, when the total of the Si powder and the SiC powder is 100 parts by mass, it is controlled such that methyl cellulose is 0.5 parts by mass, glycerin is 10 parts by mass, and water is 38 parts by mass.

The electrode portion-forming paste is then applied to the honeycomb dried body having the formed slits with an appropriate area and film thickness so as to avoid the slits and the information recognition portion as shown in FIG. 3 by a curved surface printing machine.

### (6. Production of Honeycomb Fired Body)

The honeycomb dried body with electrode portion-forming paste is then heated in an Ar atmosphere at 1400° C. for 3 hours, followed by an oxidization treatment in an air atmosphere at 1300° C. for 1 hour, to produce a pillar shaped honeycomb structure.

### (7. Injection of Filling Material)

All of the six slits of the honeycomb fired body are then filled with the same material as that used for the information recognition portion, and then heated in an air atmosphere at 1225° C. for 60 minutes. The honeycomb structure having the information recognition portion is thus produced.

The maximum thickness of the information recognition portion of the honeycomb structure and the maximum thickness of the pair of electrode layers are measured by a microscope image from the end face, indicating that the maximum thickness of the information recognition portion is 0.35 times the maximum thickness of the pair of electrode layers.

### (8. Measurement of Color Tone)

A black-colored two-dimensional code is displayed on the information recognition portion of the resulting honeycomb structure by laser irradiation. The two-dimensional code can follow a resistance value data upon reading.

Subsequently, the chromaticities x, y, and luminance Y in the CIExyY color space as defined by JIS Z 8781-3 (2016), which is the color tone of the information recognition portion, are measured using a color luminance meter CS-100A from Konica Minolta, Inc., under conditions of room temperature and 85% RH or less. LED lighting is used as a light source for the measurement.

The measurement is performed at any three locations in the information recognition portion, and an average value is calculated. As a result, it is confirmed that the area of the color tone range of 0.36≤x≤0.38, 0.38≤y≤0.41, and 14≤Y≤100 is 2990 mm². It is also confirmed that the variation in the color tone of the information recognition portion is in a range within ±2 with respect to the median value of the luminance Y of the color tone of the information recognition portion.

### (9. Measurement of Overall Symbol Grade of Information Recognition Portion)

The overall symbol grade as defined in the ISO/IEC15415 standard of the information recognition portion is evaluated, indicating that the overall symbol grade is B, which is very good visibility.

### (10. Measurement of Volume Resistivity of Information Recognition Portion and Electrode Layer)

Each of the volume resistivities R₁ and R₂ of the information recognition portion and the electrode layers is measured at 25° C. by the four-terminal method, confirming that the ratio R₁/R₂ of the volume resistivity R₁ of the information recognition portion to the volume resistivity R₂ of the electrode layers is 100 or more.

### (11. Discussion)

In the honeycomb structure produced in Embodiment 1, it is confirmed that in the CIExyY color space as defined by JIS Z 8781-3, the area of the color tone range of 0.36≤x≤0.38, 0.38≤y≤0.41, 14≤Y≤100 is 250 mm² or more for the information recognition portion. Therefore, the difference in color tone is clarified with respect to the outer peripheral wall of the honeycomb structure, and the displayed information can be well recognized.

### DESCRIPTION OF REFERENCE NUMERALS

10 honeycomb structure
11 honeycomb structure portion
12 outer peripheral wall
13a, 13b electrode layer
18 cell
19 partition wall
21 slit
22 Information recognition portion
30 electrically heating support
33a, 33b metal electrode

1. A honeycomb structure, comprising:
a honeycomb structure portion comprising: an outer peripheral wall; a partition wall disposed on an inner side of the outer peripheral wall, the partition wall defining a plurality of cells, each of the cells extending from one end face to other end face to form a flow path; and at least one slit cut radially inward from the outer peripheral wall, the at least one slit extending in an extending direction of the cells; and
a pair of electrode layers provided on an outer surface of the outer peripheral wall so as to extend in a form of a band in a flow path direction of the cells across a central axis of the honeycomb structure portion,
wherein the outer peripheral wall and the partition comprise SiC and Si,
wherein the at least one slit is filled with a filling material, and
wherein at least one of two regions sandwiched between the pair of electrode layers on the outer surface of the outer peripheral wall has an information recognition portion for displaying information, and the information recognition portion has an area of a color tone range of 0.36≤x≤0.38, 0.38≤y≤0.41, 14≤Y≤100 of 250 mm² or more in a CIExyY color space as defined in JIS Z 8781-3.

2. The honeycomb structure according to claim 1, wherein the information recognition portion forms a part of the outer peripheral wall.

3. The honeycomb structure according to claim 1, wherein the information recognition portion is provided on an outer surface of the outer peripheral wall.

4. The honeycomb structure according to claim 3, wherein a maximum thickness of the information recognition portion is 0.01 times or more and 2.0 times or less that of the pair of electrode layers.

5. The honeycomb structure according to claim 1, wherein a material making up the information recognition portion comprises at least one of SiC, SiO₂, Al₂O₃ and MgO as a main component.

6. The honeycomb structure according to claim 1, wherein the honeycomb structure has information displayed on the information recognition portion, and the information is information displayed by laser irradiation or information displayed by an ink.

7. The honeycomb structure according to claim 1, wherein the information displayed on the information recognition portion has an overall symbol grade of D or more.

8. The honeycomb structure according to claim 1, wherein a variation in color tone of the information recognition portion is in a range within ±2 with respect to a median value of luminance of a color tone of the information recognition portion.

9. The honeycomb structure according to claim 1, wherein a ratio R₁/R₂ of a volume resistivity R₁ of the information recognition portion to a volume resistivity R₂ of the electrode layers is 100 or more.

10. The honeycomb structure according to claim 1, wherein the honeycomb structure comprises a plurality of the information recognition portions.

11. An electrically heating support comprising:
the honeycomb structure according to claim 1; and
a pair of metal electrodes electrically connected to the electrode layers of the honeycomb structure.

12. An exhaust gas purification device, comprising:
the electrically heating support according to claim 11; and
a metallic cylindrical member for holding the electrically heating support.
